(19) United States
(12) Patent Application Publication
(10) Pub. No.: US 2005/0047573 A1
(43) Pub. Date: Mar. 3, 2005

(54) Controlling access to features of call processing software

(76) Inventors: Jeffrey M. Cameron, Omaha, NE (US); Bradley T. Kenyon, Omaha, NE (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/801,035

(22) Filed: Mar. 16, 2004

Related U.S. Application Data
(60) Provisional application No. 60/498,362, filed on Aug. 28, 2003.

(51) Int. Cl. H04M 3/42

(52) U.S. Cl. 379/201.12; 379/201.02

(57) ABSTRACT

A method of, apparatus for, and computer-readable medium containing instructions for controlling access to features of call processing software are described. A method includes receiving a license file and in response to a request to enable a call processing feature, checking if the license file indicates the feature is valid for a call processing system. If the feature is indicated as valid, the requested call processing feature on the call processing system is allowed to be enabled. A provisioning system includes a processor and a memory coupled to the processor. The memory has a license file and instructions causing the processor to, in response to a request to enable a call processing feature, check if the license file indicates the feature is valid for a call processing system including call processing software. If the feature is valid, the feature of the call processing software is allowed to be enabled.

### RELATED APPLICATIONS

The present application hereby claims the benefit of priority of Provisional Application Ser. No. 60/498,362 filed on Aug. 28, 2003 and hereby incorporates said Provisional Application herein in its entirety by reference.

### FIELD OF THE INVENTION

The present invention relates to controlling access to features of call processing software.

### BACKGROUND

Numerous telecommunications carriers, e.g., AT&T, Verizon, and WorldCom, provide telecommunications services to users. Carriers use multiple types of communication mechanisms, e.g., landline, fiber optic, satellite, cellular, and microwave, to enable communication between users of carrier-provided telecommunication services.

In order to provide telecommunication services to users, carriers employ call processing software. One such commercially available call processing software is OpenCall software available from the Hewlett-Packard Development Company, L.P.

It is important to be able to restrict carrier access to features provided to subscribers. Prior systems fall into one of several categories for handling feature control of call processing software: no control; honor system control; and version control. Systems under the no control category lack any functionality in the carrier level call processing software for controlling carrier access and enablement of call processing features. That is, carriers possessing the call processing software are able to enable or disable call processing features at will. Differentiation and capture of revenue on a per feature basis is not possible for call processing software lacking control functionality.

Systems under the honor system control category rely on the honor and trustworthiness of the carrier to control carrier access and enablement of call processing features. That is, the honor system is basically the same as the no control category. The call processing software lacks any functional controls for controlling carrier access to enabling and disabling call processing features.

Systems under the version control category rely on releasing different versions of the call processing software having different functionality enabled or disabled, as desired, depending on the carrier need and payment. This approach engenders numerous additional complexities and problems, requiring at least one, and more often multiple, versions of call processing software for each carrier. Each version of the call processing software must be maintained and updated for each new revision of the call processing software.

It is important to be able to restrict carrier access based on a system identifier, such as a hardware platform identifier, e.g., system name. Carrier access that is unrestricted by a system identifier allows unlimited carrier copying of the call processing software to one or more unlicensed call processing systems. Such copying directly impacts the revenue of the call processing software developer in terms of lost license sales and in terms of increased support requests for call processing software not purchased by the carrier.

It is important to have no or minimal performance impact on the call processing transaction path. Other considered solutions involved insertion of feature licensing logic in the call processing transaction path and resulting in multiple invocation of the licensing logic per call transaction. The additional logic and invocations of the logic resulted in costly reduction of system performance.

### SUMMARY

The present invention provides a method, apparatus, and computer-readable medium containing instructions for controlling access to features of call processing software.

A method aspect includes receiving a license file and in response to a request to enable a call processing feature, checking if the license file indicates the feature is valid for a call processor system. If the feature is indicated as valid, the requested call processing feature on the call processing system is allowed to be enabled.

An apparatus aspect of a call processing system includes a processor and a memory coupled to the processor. The memory has a license file and instructions causing the processor to, in response to a request to enable a call processing feature, check if the license file indicates the feature is valid for the call processing system. If the feature is valid, the feature is allowed to be enabled.

A computer-readable medium aspect includes a license file and instructions for execution by a processor to cause the processor to, in response to a request to enable a call processing feature, check if the license file indicates the feature is valid for the call processing system. If the feature is valid, the feature is allowed to be enabled.

Still other aspects and advantages of the present invention will become readily apparent to those skilled in the art from the following detailed description, wherein embodiments of the invention are shown and described, simply by way of illustration of the best mode contemplated of carrying out the invention. As will be realized, the invention is capable of other and different embodiments, and its several details are capable of modifications in various obvious respects, all without departing from the invention.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level block diagram of a licensing architecture according to an embodiment of the present invention;

FIG. 2 is a high level block diagram of an example licensing architecture in use according to an embodiment of the present invention;

FIG. 3 is a high level block diagram of a license file creation and distribution architecture according to an embodiment of the present invention; and

FIG. 4 is a high level block diagram of a computer system on which an embodiment of the present invention is executable.

### DETAILED DESCRIPTION

In coordination with the above-referenced provisional application, an embodiment of the present invention enables licensing call processing features of call processing software. In an embodiment, the present invention relates to call processing software executing at a telecommunications carrier level supporting telecommunications service to wireless equipment users.

A mechanism for licensing call processing features includes feature level licensing. Feature level licensing provides a method through which execution of optional (extra cost, non-base) features is limited to customers, i.e., carrier level companies, purchasing the feature from the call processing software developer or vendor of the call processing software. Licensing is based on the concept of controlling access to data elements that, in turn, enable functional areas of the product, i.e., call processing software, being controlled.

For example, in the OpenCall Home Location Register (HLR), access to system-level attributes enabling/disabling call processing features is controlled through licensing. The HLR is a database containing information about subscribers, i.e., end-users, of a telecommunication network. If a feature enablement attribute can not be modified because the feature has not been licensed, the feature cannot be activated on the call processing software. That is, a license allowing a carrier to enable a particular feature of the call processing software has not been obtained.

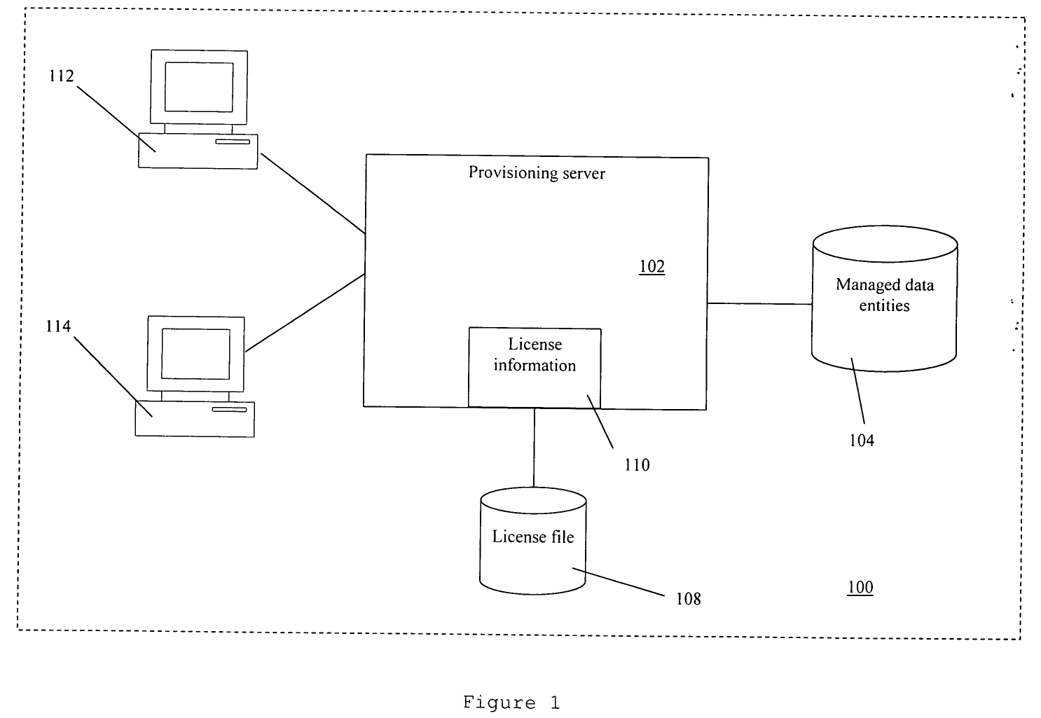

By implementing licensing through a provisioning system, e.g., system 100 as in an embodiment of the present invention depicted in FIG. 1 and described below, call processing software execution performance impacts due to licensed feature determination are minimized because costly operations are limited to startup processing of the provisioning system 100. Licensing control of the feature enablement flags eliminates the need for additional transaction path logic during execution of the call processing software.

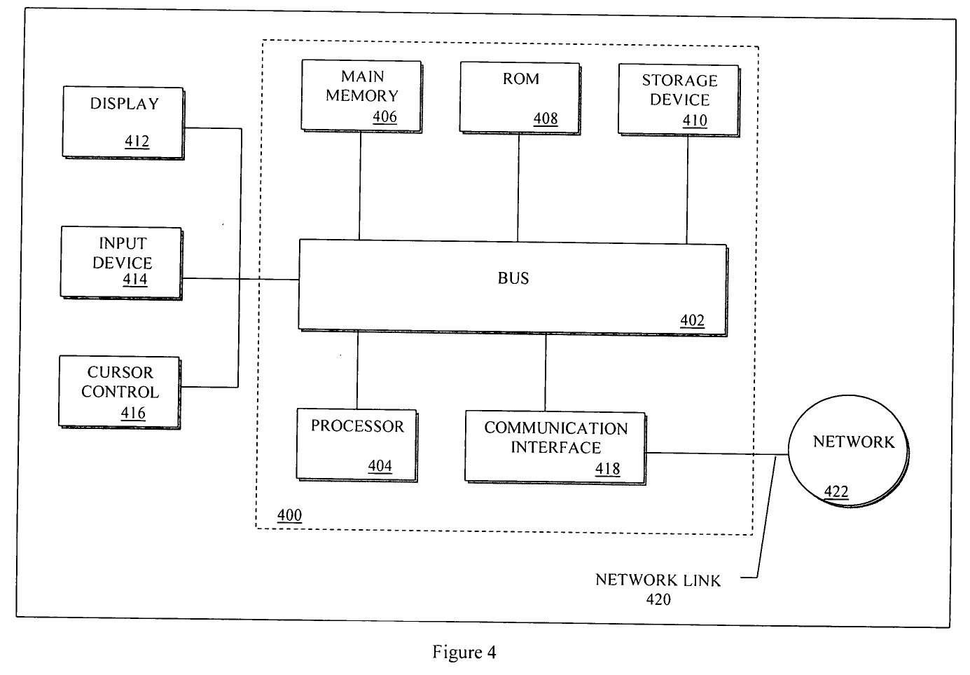

Provisioning system 100 includes a provisioning server 102, e.g., a computer system 400 as described below in conjunction with FIG. 4, accessing a provisioning server managed data entities data store 104 and a license file 108. Information stored in license file 108 is used in conjunction with license information 110 stored in memory in provisioning server 102 to allow the enablement of call processing features for the provisioning server. A computer system executes a software executable to display a graphical user interface, e.g., GUI computer 112, and a computer system executes a software executable to display a generic command line interface (GCI), e.g., GCI computer 114, access provisioning server 102.

An attempt by a software executable executing on either computer system 112 or 114 to modify a licensing controlled data element stored in managed data entities data store 104 causes the provisioning server 102 to check licensing information 110 to determine if modifications to the data element are allowed. If modifications are not allowed, a descriptive error response is provided to support personnel at either computer system 112 or 114 indicating that the requested modification is not allowed due to license restrictions and the modification is not performed.

If modifications are allowed, the modification is performed on the licensing controlled data element in data store 104. In cases where the license controlled data element is a flag activating application functionality, the functionality is activated on provisioning server 102.

In an embodiment, encrypted license information accessible to provisioning server 102 controls which products are under licensing control. Included in the encrypted license information is a list of “provisioning applications” that make up the product, i.e., the provisioning server 102. During provisioning server 102 startup, if a license file 108 is not available for a provisioning application identified as being under licensing control, i.e., based on the provisioning applications list in the license master information, the provisioning application is not made available to the carrier.

A customer specific license file, e.g., license file 108 of FIG. 1, containing feature information is shipped along with releases of call processing software, e.g., software executing on provisioning server 102. In alternate embodiments, the license file may be an encrypted, ASCII format file that is read in, decrypted and cached in memory by the provisioning server 102.

In addition to feature level enablement, the feature licensing scheme also supports system name and application release level validation. An individual license file 108 is valid for a single call processing software on a specific customer system, i.e., an instance of provisioning server 102.

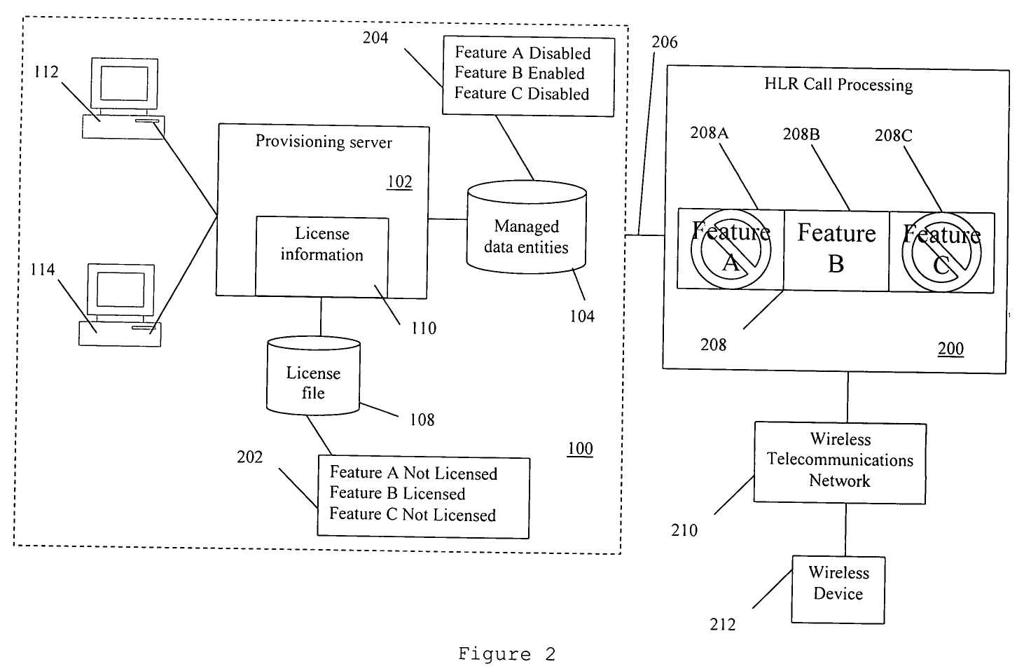

With reference to the exemplary system of FIG. 2, the provisioning server 102 loads the license information from license file 108, i.e., processor 404 (FIG. 4) reads license file 108 into main memory 406 (FIG. 4). Provisioning server 102 determines which applications, i.e., components of the call processing software executing on a call processing system 200, support licensing by inspecting the contents of the license information. A license entry in the license information for a product includes a list of the applications usable in connection with the provisioning server 102 that make up the product.

Provisioning server 102 locates and loads the product specific license file(s) 108. The license file 108 contains information defining which data elements, i.e., entities in managed data entities data store 104, have controlled access. For example, licensing information listing 202 within license file 108 indicates the license status of Features A, B, and C. Also included in the license file 108 are system level validation items, including the hardware platform system name and application release level.

In an embodiment, if the license file 108 is not found at provisioning server 102 or is invalid for an application supporting licensing (as determined with reference to the license information), access to all of the provisioning applications listed as part of the call processing software is denied through both the GUI and GCI computer systems 112, 114. System name and release mismatch conditions are exemplary reasons for a license file 108 to be determined invalid by provisioning server 102.

The license file information 202 identifies individual data elements within managed data entities data store 104 by entity and property name and determines whether licensing allows or prohibits modification of the property. Internal instance variables in the provisioning system 102 configuration are set to indicate both the entity and property name, e.g., entity licensing information 204 of FIG. 2.

After a request is made from either the GUI computer 112 or GCI computer 114 to modify a property, the licensing flag in entity licensing information 204 is checked for the data element in managed data entities data store 104. If not prohibited by licensing, the modification proceeds. If modification is prohibited, a descriptive error message is returned to support personnel at the appropriate computer system 112, 114.

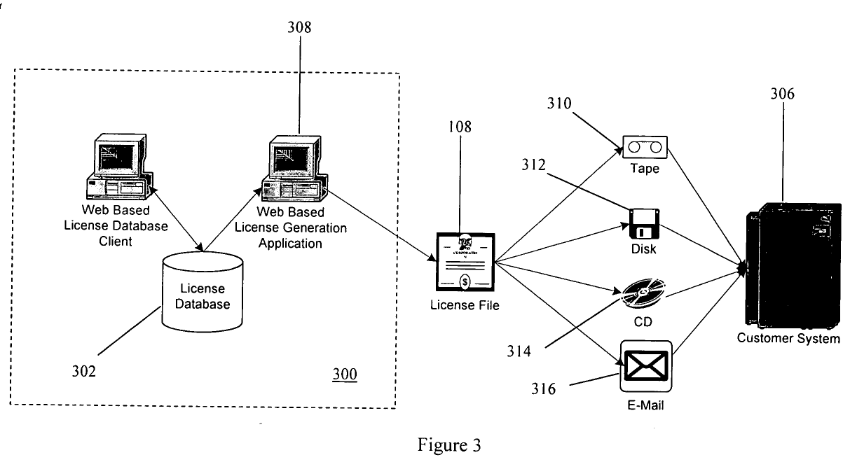

The License File Creation (LFC) Sub-System 300, such as depicted in FIG. 3, provides a method for accumulating license-related information and generating license files 108. LFC data is stored in a license database 302. The information stored in the license database 302 of LFC 300 includes: customer, customer systems, features, purchased features, actual license information, etc.

Customer and system information provides a listing of all customer systems for which license files 108 need to be generated. Feature information defines the entity and property name controlled by the feature as discussed above with respect to license information listing 202 and 204. Other feature information maintained includes the release of the call processing software of call processing system 200 in which a feature was introduced, whether the feature is standard or optional, when the release was made a standard item, etc.

Purchased feature information is created on a customer-by-customer basis. A feature to customer relationship is created as part of this processing. A “purchase” is applicable to one or more customer systems, such as a customer system 306 including a call processing system 200 (shown and described in conjunction with FIG. 2).

A license file 108 is generated based on the list of purchased features for a specific customer. License file 108 is generated for single or multiple systems in a single operation and each license file is applicable to a single provisioned application on a single customer system 306.

The license file 108, an ASCII text type item, is transmittable via both physical and electronic delivery methods as shown in FIG. 3. The methods shown in FIG. 3, i.e., tape 310, disk 312, compact disc (CD) 314, and electronic mail (e-mail) 316, are meant to be illustrative in nature only and should not be construed as being a limitation on the scope of possibilities for delivering license file 108.

Feature Level licensing is implemented through a provisioning interface 206. Features in the OpenCall HLR, i.e., call processing system 200, are enabled at the system level by setting a global flag, e.g., a flag 208A, 208B, and 208C of flag set 208. The flag is then evaluated by the call processing logic in call processing system 200 to determine if a particular section of feature logic is to be executed, i.e., whether a wireless device 212 using wireless telecommunications network 210 connected to call processing system 200 is able to access a particular wireless application.

By limiting the provisioning access to these flags through the use of a license file 108, the set of features available to a particular call processing system and provisioning server, i.e., a telecommunications carrier, is limited to features deemed to be “product standard” and those optional features purchased by the carrier.

Implementation of licensing through controlled access to the feature enablement flag set 208 keeps license related processing out of the call processing logic of the call processing system 200 and eliminates the impact to network traffic related processing.

Feature enablement flags 208A-C of flag set 208 are configured in the provisioning configuration such that a license file check is performed upon each attempt to enable a flag 208A-C through either the GUI computer system 112 or the GCI computer system 114. If the license information 110 indicates that the feature is valid for the executing system 100, the update to the flag 208A-C is allowed. If the license information 110 shows that the feature has not been licensed, the update is disallowed with an appropriate error message to either GUI computer system 112 or GCI computer system 114.

The license file 108 is read by the provisioning server 102 during initialization processing of the provisioning server to obtain license information 110. In an embodiment, the license information 110 is decrypted and validated by provisioning server 102 to ensure that no tampering has occurred to the contents of the license information 110. The license information 110 is then stored in memory of provisioning server 102 for efficient access.

The license file 108 contains system identification information, and a series of feature specific information blocks. The feature blocks include configuration information and whether the feature is allowed for the specific system 200.

License files 108 are “electronically” deliverable to a carrier and are transmittable via E-mail as an attachment, FTP, and hard media (CD/tape/etc as shown and described above with reference to FIG. 3). In an embodiment, the content of license file 108 is encrypted.

FIG. 4 is a block diagram illustrating an exemplary computer system 400 upon which an embodiment of the invention may be implemented. The present invention is usable with currently available computer systems, and is also applicable to personal computers, mini-mainframes, servers and the like.

Computer 400 includes a bus 402 or other communication mechanism for communicating information, and a processor 404 coupled with the bus 402 for processing information. Computer 400 also includes a main memory 406, such as a random access memory (RAM) or other dynamic storage device, coupled to the bus 402 for storing a license file, license information, and a database according to an embodiment of the present invention and instructions to be executed by processor 404. Main memory 406 also may be used for storing temporary variables or other intermediate information during execution of instructions to be executed by processor 404. Computer 400 further includes a read only memory (ROM) 408 or other static storage device coupled to the bus 402 for storing static information and instructions for the processor 404. A storage device 410 is coupled to the bus 402 for storing instructions.

Computer 400 may be coupled via the bus 402 to a display 412, such as a flat panel touch-sensitive display, for displaying an interface to a user. Input device 414, such as a keyboard including alphanumeric and function keys, is coupled to the bus 402 for communicating information and command selections to the processor 404. Another type of user input device is cursor control 416, such as a stylus, pen, mouse, a trackball, or cursor direction keys for communicating direction information and command selections to processor 404 and for controlling cursor movement on the display 412. This input device typically has two degrees of freedom in two axes, a first axis (e.g., x) and a second axis (e.g., y) allowing the device to specify positions in a plane.

The invention is related to the use of computer 400, such as the depicted computer of FIG. 4, to control access to features of a call processing system. According to an embodiment of the invention, data is stored and accessed from a database by computer 400 in response to processor 404 executing sequences of instructions contained in main memory 406 in response to input received via input device 414, cursor control 416, or communication interface 418. Such instructions may be read into main memory 406 from another computer-readable medium, such as storage device 410. Support personnel interact with the call processing software and via an application providing a user interface displayed (as described below) on display 412.

However, the computer-readable medium is not limited to devices such as storage device 410. For example, the computer-readable medium may include a floppy disk, a flexible disk, hard disk, magnetic tape, or any other magnetic medium, a compact disc-read only memory (CD-ROM), any other optical medium, punch cards, paper tape, any other physical medium with patterns of holes, a random access memory (RAM), a programmable read only memory (PROM), an erasable PROM (EPROM), a Flash-EPROM, any other memory chip or cartridge, a carrier wave embodied in an electrical, electromagnetic, infrared, or optical signal, or any other medium from which a computer can read. Execution of the sequences of instructions contained in the main memory 406 causes the processor 404 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer 400 also includes a communication interface 418 coupled to the bus 402 and providing two-way data communication as is known in the art. For example, communication interface 418 may be an integrated services digital network (ISDN) card, a digital subscriber line (DSL) card, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals which carry digital data streams representing various types of information. Of particular note, the communications through interface 418 may permit transmission or receipt of instructions and data to be stored and accessed from the database. For example, two or more computers 400 may be networked together in a conventional manner with each using the communication interface 418.

Network link 420 typically provides data communication through one or more networks to other data devices. For example, network link 420 may provide a connection through network 422 to another computer system (not shown). Network 422 uses electrical, electromagnetic or optical signals which carry digital data streams. The signals through the various networks and the signals on network link 420 and through communication interface 418, which carry the digital data to and from computer 400, are exemplary forms of carrier waves transporting the information.

Computer 400 can send messages and receive data, including program code, through the network(s), network link 420 and communication interface 418.

It will be readily seen by one of ordinary skill in the art that the present invention presents a solution to the problems set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof

1. A method of controlling access to call processing features of call processing software, the method comprising the steps of:
receiving a license file for call processing software;
in response to a request to enable a call processing feature, checking if the license file indicates the feature is valid for a call processing system; and
if the feature is indicated as valid for the call processing system, allowing enablement of the requested call processing feature on the call processing system.

2. The method of claim 1, wherein the received license file includes a system identifier attribute and wherein the checking step further comprises the steps of:
determining if the license file system identifier attribute corresponds to the system identifier of the call processing system; and
if the license file system identifier attribute corresponds to the system identifier of the call processing system, indicating the license information is valid.

3. The method of claim 1, wherein the received license file includes a call processing software version information attribute and wherein the checking step further comprises the steps of:
determining if the call processing software version information attribute of the received license file corresponds to the call processing software version on the call processing system; and
if the call processing software version information attribute corresponds to the call processing software version on the call processing system, indicating the license information is valid.

4. The method of claim 1, wherein the received license file indicates call processing software features able to be enabled.

5. The method of claim 1, wherein the received license file indicates disabled call processing software features.

6. The method of claim 1, wherein the received license file is encrypted and wherein the checking step further comprises the step of:
decrypting the encrypted license file.

7. The method of claim 1, wherein the received license file is received in electronic form.

8. A provisioning system for controlling access to call processing features of call processing software comprising:
a processor for receiving and transmitting data; and
a memory coupled to the processor, the memory having stored therein a license file and instructions causing the processor to, in response to a request to enable a call processing feature, check if the license file indicates the feature is valid for a call processing system including the call processing software, and if the feature is valid, allowing enablement of the requested call processing feature of the call processing software.

9. The provisioning system of claim 8, wherein the received license file includes a system identifier attribute and wherein the instructions stored in memory further cause the processor to:
determine if the license file system identifier attribute corresponds to the system identifier of the call processing system; and
if the license file system identifier attribute corresponds to the system identifier of the call processing system, indicate the license information is valid.

10. The provisioning system of claim 8, wherein the received license file includes a call processing software version information attribute and wherein the instructions stored in memory further cause the processor to:
determine if the call processing software version information attribute of the received license file corresponds to the call processing software version on the call processing system; and
if the call processing software version information attribute corresponds to the call processing software version on the call processing system, indicate the license information is valid.

11. The provisioning system of claim 8, wherein the received license file indicates call processing software features able to be enabled.

12. The provisioning system of claim 8, wherein the received license file indicates disabled call processing software features.

13. The provisioning system of claim 8, wherein the received license file is encrypted and wherein the instructions stored in memory further cause the processor to:
decrypt the encrypted license file.

14. A computer-readable medium comprising:
at least one sequence of machine executable instructions;
a license file; and
the medium bearing the executable instructions, wherein execution of the instructions by one or more processors cause the one or more processors to:
in response to a request to enable a call processing feature, check if the license file indicates the feature is valid for the processor, and if the feature is valid, allowing enablement of the requested call processing feature of the call processing software.

15. The computer-readable medium of claim 14, wherein the received license file includes a system identifier attribute and wherein the instructions stored in memory further cause the processor to:
determine if the license file system identifier attribute corresponds to the system identifier of the call processing system; and
if the license file system identifier attribute corresponds to the system identifier of the call processing system, indicate the license information is valid.

16. The computer-readable medium of claim 14, wherein the received license file includes a call processing software version information attribute and wherein the instructions stored in memory further cause the processor to:
determine if the call processing software version information attribute of the received license file corresponds to the call processing software version on the call processing system; and
if the call processing software version information attribute corresponds to the call processing software version on the call processing system, indicate the license information is valid.

17. The computer-readable medium of claim 14, wherein the received license file indicates call processing software features able to be enabled.

18. The computer-readable medium of claim 14, wherein the received license file indicates disabled call processing software features.

19. The computer-readable medium of claim 14, wherein the received license file is encrypted and wherein the instructions stored in memory further cause the processor to:
decrypt the encrypted license file.

20. The computer-readable medium of claim 14, wherein the received license file is received in electronic form.
